(19) United States
(12) Patent Application Publication
(10) Pub. No.: US 2018/0210726 A1
(43) Pub. Date: Jul. 26, 2018

(54) APPARATUS AND METHOD FOR UPDATING FIRMWARE OF BLACK BOX FOR VEHICLE

(71) Applicant: SAMSUNG ELECTRO-MECHANICS CO., LTD., Suwon-si (KR)

(72) Inventors: Hee Sung JUN, Suwon-si (KR); Seok June HONG, Suwon-si (KR)

(73) Assignee: SAMSUNG ELECTRO-MECHANICS CO., LTD., Suwon-si (KR)

(21) Appl. No.: 15/815,076

(22) Filed: Nov. 16, 2017

(30) Foreign Application Priority Data
Jan. 24, 2017 (KR) 10-2017-0010952

(51) Int. Cl. G06F 9/445; G06F 9/44; H04L 29/08; H04W 4/00

(52) U.S. Cl. CPC G06F 8/665; G06F 8/71; H04W 88/02; H04W 4/008; H04L 67/34

(57) ABSTRACT

An apparatus f for updating firmware of a black box for a vehicle includes an infotainment device configured to receive information regarding a current version of firmware from the black box and to transmit information regarding a firmware source of an updated version of the firmware to the black box, and a wireless communications terminal configured to receive the information regarding the current firmware version from the infotainment device, to download the firmware source of the updated version of the firmware from a server, and to transmit the downloaded firmware source of the updated version of the firmware to the infotainment device.

### CROSS-REFERENCE TO RELATED APPLICATION(S)

This application claims the benefit under 35 USC 119(a) of Korean Patent Application No. 10-2017-0010952 filed on Jan. 24, 2017 in the Korean Intellectual Property Office, the entire disclosure of which is incorporated herein by reference for all purposes.

### BACKGROUND

### 1. Field

This application relates to an apparatus and a method for updating firmware of a black box for a vehicle.

### 2. Description of Related Art

In-vehicle infotainment systems are increasing becoming prevalent in vehicles. These In-vehicle infotainment systems commonly incorporate navigation, as well as audio and video systems. In addition, the in-vehicle infotainment system may include other functions such as, for example, driving and parking assistance, and safety diagnosis.

As wireless communications terminals such as smartphones are being widely used, interest in providing functionalities by linking in-vehicle infotainment systems to wireless communications terminals has recently increased. As in-vehicle infotainment systems are linked to the wireless communications terminals, communications functions, applications, and smartphone contents may be used in in-vehicle infotainment systems, while an operating environment that is familiar to users is provided in the in-vehicle infotainment system.

A black box, provided in a vehicle, is a device for recording an accident occurring during driving, an external impact to a vehicle that occurs while the vehicle is parked, or other vehicular activities. To update the firmware of such a black box, a firmware source, provided by a manufacturer, is stored in a memory device and the memory device is connected to the black box.

### SUMMARY

This Summary is provided to introduce a selection of concepts in a simplified form that are further described below in the Detailed Description. This Summary is not intended to identify key features or essential features of the claimed subject matter, nor is this Summary intended to be used as an aid in determining the scope of the claimed.

In one general aspect, there is provided an apparatus for updating firmware of a black box for a vehicle, the apparatus including an infotainment device configured to receive information regarding a current version of firmware from the black box and to transmit information regarding a firmware source of an updated version of the firmware to the black box, and a wireless communications terminal configured to receive the information regarding the current firmware version from the infotainment device, to download the firmware source of the updated version of the firmware from a server, and to transmit the downloaded firmware source of the updated version of the firmware to the infotainment device.

The wireless communications terminal may be configured to request the server for information regarding a version of firmware available on the server, to receive the information regarding the version of the firmware on the server, to compare the version of the firmware on the server with the information regarding the current firmware version of the black box, and to request the server to transmit the firmware source of the firmware on the server.

The infotainment device and the wireless communications terminal may communicate with each other using any one of Bluetooth or Wi-Fi.

The infotainment device and the black box may communicate with each other in an Ethernet scheme.

The infotainment device may be configured to receive an user input to update the firmware and to receive the firmware source of an updated version of the firmware from the wireless communications terminal.

The wireless communications terminal may be configured to request the server to transmit the firmware source of the firmware on the server, in response to the version of the firmware on the server being more recent than the current firmware version of firmware on the black box.

In another general aspect, there is provided a method of a wireless communications terminal for updating firmware of a black box for a vehicle through an infotainment device of the vehicle, the method including receiving the firmware source of an updated version of the firmware from the wireless communications terminal, in response to information regarding the firmware source of the updated version of the firmware of the black box existing in the wireless communications terminal, and transmitting the firmware source of the updated version of the firmware to the infotainment device.

The downloading of the firmware source of the updated version of the firmware may include requesting the server for information regarding the updated version of the firmware of the server, receiving the information regarding the updated version of the firmware of the server, and comparing the information of the received updated version of the firmware on the server with the information regarding the current version of the firmware of the black box, requesting the server to transmit the firmware source of the updated version of the firmware, in response to the information regarding the updated version of firmware of the server being more recent than the information regarding the current version of the firmware of the black box, and downloading the firmware source of the updated version of the firmware.

The transmitting of the firmware source of the updated version of the firmware may be executed in response to the infotainment device receiving a user input to update the current version of the firmware.

In one general aspect, there is provided a method of an infotainment device of the vehicle for updating firmware of a black box for a vehicle using a firmware source of an updated version of the firmware received from a wireless communications terminal, the method including receiving the firmware source of an updated version of the firmware from the wireless communications terminal, in response to information regarding the firmware source of the updated version of the firmware of the black box existing in the wireless communications terminal, and transmitting the firmware source of the updated version of the firmware to the black box.

The method may include receiving, at the black box, the firmware source of the updated version of the firmware from the infotainment device and updating the firmware based on the received firmware source of the updated version of the firmware.

The updating of the received firmware source of an updated version of the firmware may include requesting the black box for a firmware update and receiving ACK (acknowledgement), transmitting the firmware source of an updated version of the firmware to the black box, and storing, at the black box, the firmware source of an updated version of the firmware in a firmware memory.

The method may include rebooting the black box and running the black box using the firmware source of the updated version of the firmware.

Other features and aspects will be apparent from the following detailed description, the drawings, and the claims.

### BRIEF DESCRIPTION OF DRAWINGS

FIG. 1 is a diagram illustrating an example of an apparatus for updating firmware of a black box for a vehicle.

FIG. 2 is a diagram illustrating an example of a method for updating firmware of a black box.

FIG. 3 is a diagram illustrating an example of an operation of downloading a firmware source of an updated version of the firmware.

FIG. 4 is a diagram illustrating an example of an operation of updating the firmware source of an updated version of the firmware.

Throughout the drawings and the detailed description, the same reference numerals refer to the same elements. The drawings may not be to scale, and the relative size, proportions, and depiction of elements in the drawings may be exaggerated for the purposes of clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after gaining a thorough an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

Throughout the specification, when an element, such as a layer, region, or substrate, is described as being “on,” “connected to,” “coupled to,” “over,” or “covering” another element, it may be directly “on,” “connected to,” “coupled to,” “over,” or “covering” the other element, or there may be one or more other elements intervening therebetween. In contrast, when an element is described as being “directly on,” “directly connected to,” “directly coupled to,” “directly over,” or “directly covering” another element, there can be no other elements intervening therebetween.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items.

Due to manufacturing techniques and/or tolerances, variations of the shapes shown in the drawings may occur. Thus, the examples described herein are not limited to the specific shapes shown in the drawings, but include changes in shape that occur during manufacturing.

All documents cited in the present disclosure, including published documents, patent applications, and patents, may be incorporated herein in their entirety by reference in the same manner as when each cited document is separately and specifically incorporated or incorporated in its entirety.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

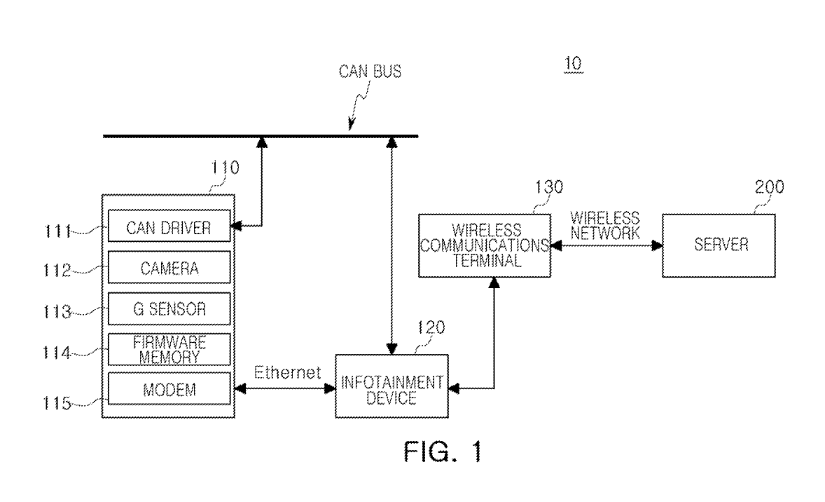

FIG. 1 is a diagram illustrating an apparatus for updating firmware of a black box for a vehicle 10.

Referring to FIG. 1, a apparatus for updating firmware of a black box for a vehicle 10 is include a black box 110, an infotainment device 120, and a wireless communications terminal 130.

In an example, apparatus for updating firmware of a black box for a vehicle 10 is provided in various vehicles. The vehicle refers to any mode of transportation, delivery, or communication such as, for example, for example, an automobile, a truck, a tractor, a scooter, a motorcycle, a cycle, an amphibious vehicle, a snowmobile, a boat, a public transit vehicle, a bus, a monorail, a train, a tram, an autonomous vehicle, an unmanned aerial vehicle, or a drone.

In an example, the apparatus for updating firmware of a black box for a vehicle 10 is incorporated in vehicular guidance apparatuses such as, for example, cruise control, adaptive cruise control, lane keeping assist system, advanced driver-assistance system (ADAS), and land departure warning system.

In another example, the apparatus for updating firmware of a black box for a vehicle 10 is included in another device placed in the vehicle. In an example, the apparatus for updating firmware of a black box for a vehicle 10 is embodied or incorporated in various types of products such as, for example, an intelligent agent, a mobile phone, a cellular phone, a smart phone, a wearable smart device (such as, a ring, a watch, a pair of glasses, glasses-type device, a bracelet, an ankle bracket, a belt, a necklace, an earring, a headband, a helmet, a device embedded in the cloths, or an eye glass display (EGD)), a server, a personal computer (PC), a laptop, a notebook, a subnotebook, a netbook, an ultra-mobile PC (UMPC), a tablet personal computer (tablet), a phablet, a mobile internet device (MID), a personal digital assistant (PDA), an enterprise digital assistant (EDA), a digital camera, a digital video camera, a portable game console, an MP3 player, a portable/personal multimedia player (PMP), a handheld e-book, an ultra mobile personal computer (UMPC), a portable lab-top PC, a global positioning system (GPS) navigation, a personal navigation device, portable navigation device (PND), a handheld game console, an e-book, a high definition television (HDTV), a smart appliance, communication systems, image processing systems, graphics processing systems, various Internet of Things (IoT) devices that are controlled through a network, a smart vehicle, an intelligent automobile, an autonomous driving vehicle, other consumer electronics/information technology (CE/IT) device, or any other device capable of wireless communication or network communication consistent with that disclosed herein.

In another example the apparatus for updating firmware of a black box for a vehicle 10 is external to the vehicle, and is disposed in a device, such as, for example, a computer, a server, and a mobile phone, and communicates with the vehicle through wireless communication or network communication consistent with the disclosed herein.

In an example, the black box 110 for the vehicle records an image of external environments of the vehicle using a camera 112. In an example, the camera 112 is a dashboard camera. In another example, the camera 112 is installed in the exterior of the vehicle. In an example, the black box 110 records audio inside the vehicle. In an example, the black box 110 is connected to a CAN (controller area network) bus through a CAN driver 111. In an example, CAN is a network for a vehicle, where a plurality of devices share the CAN bus, a communications bus, to communicate with each other. In an example, the black box 110 provides information on a dynamic state of the vehicle sensed by a G sensor 113 to the infotainment device 120 through the CAN bus, and receives driving information from the infotainment device 120.

In an example, the black box 110 includes a firmware memory 114 for storing firmware. In an example, firmware memory 114 is a flash memory, and stores a firmware source of an updated version of the firmware and update firmware. Further description of the firmware memory 114 is provided below. In an example, the black box 110 is re-booted after the firmware source of an updated version of the firmware is stored in the firmware memory 114 and run by the firmware source of an updated version of the firmware.

To update the firmware, the black box 110 transmits a version of the firmware to the infotainment device 120, and receives the firmware source of an updated version of the firmware from the infotainment device 120. Such a transmission and reception may be performed between the black box 110 and the infotainment device 120 in an Ethernet communications manner, and the black box 110 may include a modem 115 providing an Ethernet communications function. Other communication protocols may be used without departing from the spirit and scope of the illustrative examples described.

In an example, the infotainment device 120 receives information regarding a current firmware version from the black box 110 and transmits the information regarding a current firmware version to the wireless communications terminal 130. In an example, the infotainment device 120 may include a HMI (human machine interface) for receiving an instruction for visualizing and controlling system data for the user. The infotainment device 120 may display information related to the updating of the firmware on a display through the HMI. In an example, the infotainment device 120 receives an instruction about whether or not the firmware is to be updated, through feedback provided by the user using the display.

In an example, the display is a physical structure that includes one or more hardware components that provide the ability to render a user interface and/or receive user input. The display can encompass any combination of display region, gesture capture region, a touch sensitive display, and/or a configurable area. In an example, the display can be embedded in the infotainment device 120. In an example, the display is an external peripheral device that may be attached to and detached from the infotainment device 120. The display may be a single-screen or a multi-screen display. A single physical screen can include multiple displays that are managed as separate logical displays permitting different content to be displayed on separate displays although part of the same physical screen. The display may also be implemented as an eye glass display (EGD), which includes one-eyed glass or two-eyed glasses. In an example, the display is a head-up display (HUD) or the infotainment device 120. In another example, infotainment device 120 may output information related to the updating through an audio signal.

In an example, after the infotainment device 120 receives the instruction about the updating of the firmware from the user, the infotainment device 120 may receive the firmware source of an updated version of the firmware from the wireless communications terminal 130.

In an example, the wireless communications terminal 130 comprises products such as, for example, a mobile device, a cellular phone, a smart phone, a wearable smart device (such as, a ring, a watch, a pair of glasses, glasses-type device, a bracelet, an ankle bracket, a belt, a necklace, an earring, a headband, a helmet, a device embedded in the cloths, or an eye glass display (EGD)), or any other device capable of wireless communication or network communication consistent with that disclosed herein. The wireless communications terminal 130 may communicate with a server 200 via the wireless network. Further, the wireless communications terminal 130 may communicate with the infotainment device 120 in a Bluetooth manner or a Wi-Fi manner.

In an example, the wireless communications terminal 130 receives the information regarding a current firmware version from the infotainment device 120. In an example, the wireless communications terminal 130 downloads information regarding a firmware source of an updated version of the firmware when compared to the information regarding a current firmware version from the server 200 and transmit the downloaded firmware source of an updated version of the firmware to the infotainment device 120. In an example, the wireless communications terminal 130 requests the server 200 for information regarding a current firmware version distributed by the server 200, receive the information regarding a current firmware version of the server 200 to compare it with the information regarding a firmware version of the black box 110. In an example, the wireless communications terminal 130 requests the server 200 to transmit the firmware source of an updated version of the firmware of the upper version. An operation performed by the wireless communications terminal 130 to update the firmware may be performed by application software embedded in the wireless communications terminal 130.

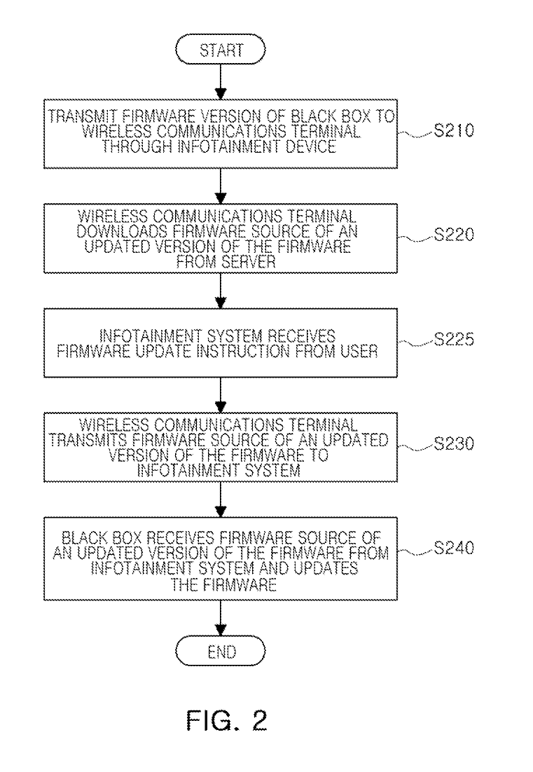

FIG. 2 is a diagram illustrating an example of a method for updating firmware of a black box. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. One or more blocks of FIG. 2, and combinations of the blocks, can be implemented by special purpose hardware-based computer that perform the specified functions, or combinations of special purpose hardware and computer instructions. In addition to the description of FIG. 2 below, the descriptions of FIG. 1 is also applicable to FIG. 2, and are incorporated herein by reference. Thus, the above description may not be repeated here.

Referring to FIGS. 1 and 2, in S210, the wireless communications terminal 130 receives the information regarding a current firmware version of the black box 110 through the infotainment device 120 of the vehicle. To transmit this information, the infotainment device 120 may secure a communications connection with the wireless communications terminal 130 using an authentication code, and secure an Ethernet socket communications connection with the black box 110.

In S220, when the information regarding a firmware source of an updated version of the firmware as compared to the information regarding a current firmware version exists in the server 200, the wireless communications terminal 130 may download the firmware source of an updated version of the firmware from the server. In S230, when the information regarding a firmware source of an updated version of the firmware as compared to the information regarding a current firmware version of the black box 110 exists in the wireless communications terminal 130, the infotainment device 120 may request the wireless communications terminal 130 to transmit the firmware source of an updated version of the firmware. In an example, the wireless communications terminal 130 transmits the firmware source of an updated version of the firmware to the infotainment device 120.

In S240, the infotainment device 120 transmits the firmware source of an updated version of the firmware to the black box 110, and the black box 110 may update the received firmware source of an updated version of the firmware.

In an example, in S225, the wireless communications terminal 130 may notify the infotainment device 120 to execute the updating of the firmware source of an updated version of the firmware prior to transmitting the firmware source of an updated version of the firmware to the infotainment device 120. In an example, the infotainment device 120 outputs information on the execution of the updating of the firmware on a display as a pop-up. In an example, the infotainment device 120 outputs the notification that the firmware source of an updated version of the firmware exists on the display. In S335, the infotainment device 120 may receive a firmware update instruction from the user. In response to the firmware update instruction, the infotainment device 120 may request the wireless communications terminal 130 to transmit the firmware source of an updated version of the firmware. Once the firmware update is performed, the infotainment device 120 may output a message that the firmware update is complete, onto the display. In an example, the infotainment device 120 outputs updates regarding the progress of the firmware update to the display.

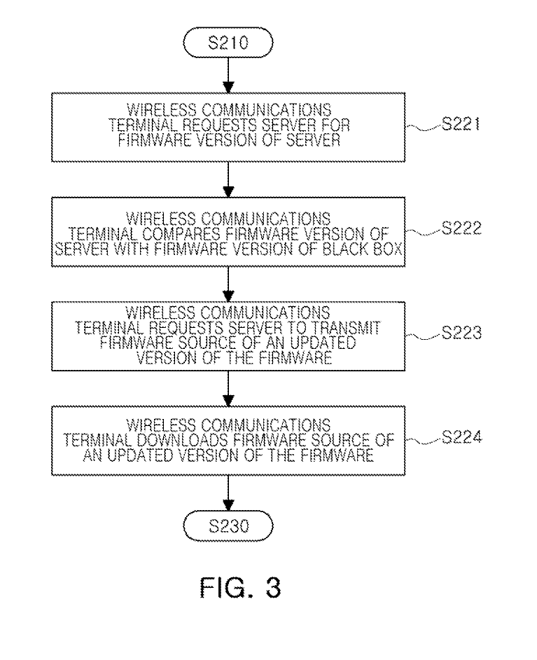

In an example, in the method for updating the firmware of the black box for the vehicle, the firmware update is performed by comparing the information regarding a current firmware version of the black box 110 with the information regarding a current firmware version of the server 200 through the wireless communications terminal 130 and the infotainment device 120. Further, the user may be notified of a need for firmware update or may provide instructions for the firmware update, through the wireless communications terminal 130 and the infotainment device 120, which are environments familiar to the user. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. One or more blocks of FIG. 3, and combinations of the blocks, can be implemented by special purpose hardware-based computer that perform the specified functions, or combinations of special purpose hardware and computer instructions. In addition to the description of FIG. 3 below, the descriptions of FIGS. 1-2 is also applicable to FIG. 3, and are incorporated herein by reference. Thus, the above description may not be repeated here.

FIG. 3 is a diagram illustrating an example of an operation of downloading a firmware source of an updated version of the firmware.

Referring to FIGS. 1 and 3, in S210, the wireless communications terminal 130 receives the information regarding a current firmware version of the black box 110. In S221, the wireless communications terminal 130 requests the server 200 for the information regarding a current firmware version of the server. In S222, when the wireless communications terminal 130 receives the information regarding a current firmware version of the server, it compares the information regarding a current firmware version of the server with the information regarding a current firmware version of the black box and determine whether or not the firmware source of an updated version of the firmware exists in the server 200. In S223, when the information regarding a current firmware version of the server 200 is the updated version of the information regarding a current firmware version of the black box 110, the wireless communications terminal 130 may request the server 200 to transmit the firmware source of an updated version of the firmware. In S224, the wireless communications terminal 130 downloads the firmware source of an updated version of the firmware from the server 200.

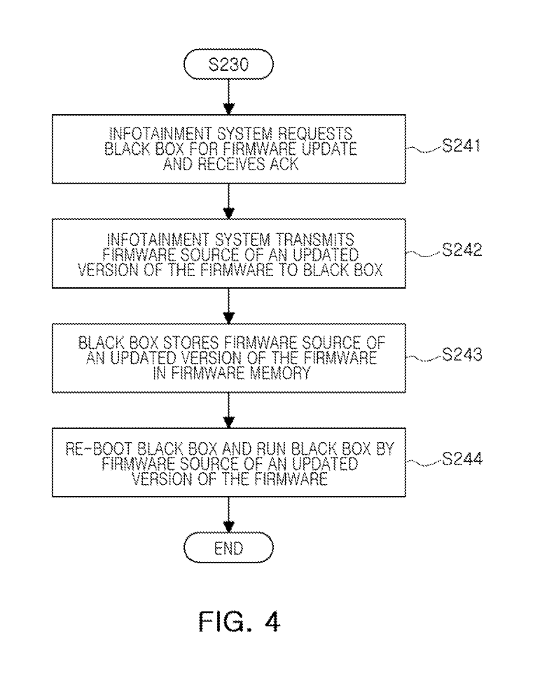

FIG. 4 is a diagram illustrating an example of an operation of updating the firmware source of an updated version of the firmware. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. One or more blocks of FIG. 4, and combinations of the blocks, can be implemented by special purpose hardware-based computer that perform the specified functions, or combinations of special purpose hardware and computer instructions. In addition to the description of FIG. 4 below, the descriptions of FIGS. 1-3 is also applicable to FIG. 4, and are incorporated herein by reference. Thus, the above description may not be repeated here.

Referring to FIGS. 1 and 4, in S230, the wireless communications terminal 130 transmits the firmware source of an updated version of the firmware to the infotainment device 120, and the infotainment device 120 requests the black box for the firmware update. In S241, if the infotainment device 120 receives ACK (Acknowledgement), an acknowledgement signal, from the black box 110 (S241), the infotainment device 120 transmits the firmware source of an updated version of the firmware to the black box in S242. In S243, the black box 110 stores the firmware source of an updated version of the firmware in the firmware memory 114. In S244, the black box 110 is re-booted after the storage of the firmware source of an updated version of the firmware is completed, and run by the firmware source of an updated version of the firmware.

As set forth above, the apparatuses and the methods for updating the firmware of the black box for the vehicle may easily update the firmware and provide the operating environment familiar to the user by using the wireless communications terminals and the infotainment system.

As set forth above, the apparatuses and the methods are provides for apparatuses and methods for updating firmware of a black box for a vehicle using a wireless communications terminal and an infotainment system even in the case that the black box for the vehicle is separated from the vehicle or a separate memory device is not used.

The apparatus for updating firmware of a black box for a vehicle 10, and other apparatuses, units, modules, devices, and other components illustrated in FIG. 1 that perform the operations described herein with respect to FIGS. 2-4 are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. The hardware components also access, manipulate, process, create, and store data in response to execution of the instructions or software. For simplicity, the singular term “processor” or “computer” may be used in the description of the examples described in this application, but in other examples multiple processors or computers may be used, or a processor or computer includes multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2-4 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software includes at least one of an applet, a dynamic link library (DLL), middleware, firmware, a device driver, an application program storing the method of preventing the collision. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent after gaining a thorough an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for updating firmware of a black box for a vehicle, the apparatus comprising:
an infotainment device configured to receive information regarding a current version of firmware from the black box and to transmit information regarding a firmware source of an updated version of the firmware to the black box; and
a wireless communications terminal configured to receive the information regarding the current firmware version from the infotainment device, to download the firmware source of the updated version of the firmware from a server, and to transmit the downloaded firmware source of the updated version of the firmware to the infotainment device.

2. The apparatus of claim 1, wherein the wireless communications terminal is further configured to request the server for information regarding a version of firmware available on the server, to receive the information regarding the version of the firmware on the server, to compare the version of the firmware on the server with the information regarding the current firmware version of the black box, and to request the server to transmit the firmware source of the firmware on the server.

3. The apparatus of claim 1, wherein the infotainment device and the wireless communications terminal communicate with each other using any one of Bluetooth or Wi-Fi.

4. The apparatus of claim 1, wherein the infotainment device and the black box communicate with each other in an Ethernet scheme.

5. The apparatus of claim 1, wherein the infotainment device is further configured to receive a user input to update the firmware and to receive the firmware source of an updated version of the firmware from the wireless communications terminal.

6. The apparatus of claim 2, wherein the wireless communications terminal is further configured to request the server to transmit the firmware source of the firmware on the server, in response to the version of the firmware on the server being more recent than the current firmware version of firmware on the black box.

7. A method of a wireless communications terminal for updating firmware of a black box for a vehicle through an infotainment device of the vehicle, the method comprising:
receiving information regarding a current version of firmware of the black box through the infotainment device;
downloading a firmware source of an updated version of the firmware from a server, in response to the information regarding the firmware source of the updated version of the firmware on the server being more recent than the information regarding the current version of firmware; and
transmitting the firmware source of the updated version of the firmware to the infotainment device.

8. The method of claim 7, wherein the downloading of the firmware source of the updated version of the firmware comprises:
requesting the server for information regarding the updated version of the firmware of the server;
receiving the information regarding the updated version of the firmware of the server, and comparing the information of the received updated version of the firmware on the server with the information regarding the current version of the firmware of the black box;
requesting the server to transmit the firmware source of the updated version of the firmware, in response to the information regarding the updated version of firmware of the server being more recent than the information regarding the current version of the firmware of the black box; and
downloading the firmware source of the updated version of the firmware.

9. The method of claim 7, wherein the transmitting of the firmware source of the updated version of the firmware is executed in response to the infotainment device receiving a user input to update the current version of the firmware.

10. A non-transitory computer-readable storage medium storing instructions that, when executed by a processor, causes the processor to perform the method of claim 7.

11. A method of an infotainment device of the vehicle for updating firmware of a black box for a vehicle using a firmware source of an updated version of the firmware received from a wireless communications terminal, the method comprising:
receiving the firmware source of an updated version of the firmware from the wireless communications terminal, in response to information regarding the firmware source of the updated version of the firmware of the black box existing in the wireless communications terminal; and
transmitting the firmware source of the updated version of the firmware to the black box.

12. The method of claim 11, further comprising receiving, at the black box, the firmware source of the updated version of the firmware from the infotainment device and updating the firmware based on the received firmware source of the updated version of the firmware.

13. The method of claim 12, wherein the updating of the received firmware source of an updated version of the firmware comprises:
requesting the black box for a firmware update and receiving ACK (acknowledgement);
transmitting the firmware source of an updated version of the firmware to the black box; and
storing, at the black box, the firmware source of an updated version of the firmware in a firmware memory.

14. The method of claim 11, further comprising rebooting the black box and running the black box using the firmware source of the updated version of the firmware.

15. A non-transitory computer-readable storage medium storing instructions that, when executed by a processor, causes the processor to perform the method of claim 11.
